(19) United States
(12) Patent Application Publication
(10) Pub. No.: US 2012/0003445 A1
(43) Pub. Date: Jan. 5, 2012

(54) Method For Producing A Porcelain Enamel Logo On A Porcelain Enamel Background On A Grill Component With Preselected Colors

(76) Inventor: Robert Nelson Crain, Hooksett, NH (US)

(21) Appl. No.: 13/144,623

(22) PCT Filed: Jan. 26, 2010
(86) PCT No.: PCT/US10/22116

§ 371 Date: Sep. 20, 2011

Related U.S. Application Data
(60) Provisional application No. 61/205,940, filed on Jan. 26, 2009.

(51) Int. Cl. B32B 15/04; B32B 3/10; B29C 65/02; B32B 37/06; B32B 37/14

(52) U.S. Cl. 428/210; 156/89.24

(57) ABSTRACT

A method of forming a porcelain enamel article includes firing a porcelain enamel base over a metal substrate at a first temperature. A porcelain enamel cover coat can be fired over the base at a second temperature that is lower than the first temperature. The fired cover coat forms a preselected background color. A decal applied over the cover coat can be fired at a third temperature that is lower than the second temperature. The decal has a predetermined pattern on a carrier and has at least one open region. The carrier burns off and the predetermined pattern of the decal can form a porcelain enamel image fixed to the cover coat. The porcelain enamel image can have more than one color and the at least one open region can allow the preselected background color of the cover coat to show through and be incorporated into the image to form an identical color match in the image and the cover coat.

### RELATED APPLICATION

This application claims the benefit of U.S. Provisional Application No. 61/205,940, filed on Jan. 26, 2009. The entire teachings of this application are incorporated herein by reference.

### BACKGROUND

Many sports fans cook food on grills at home, in backyards, and in the parking lots of sports stadiums before a game. A typical fan usually owns one or more items having the colors and/or logos of their favorite sports team. However, due to the amount of heat generated by a grill, it is difficult to form and maintain matching colors and logos on a grill that are associated with the sports team of choice.

### SUMMARY

The present invention can provide a porcelain enamel article, for example, a grill component, having school, team or organizational colors and logos, with identical color matches, and which can withstand heat and resist discoloration.

The present invention provides a method of forming a porcelain enamel article, including firing a porcelain enamel base over a metal substrate at a first temperature. A porcelain enamel cover coat can be fired over the base at a second temperature that is lower than the first temperature. The fired cover coat forms a preselected background color. A decal applied over the cover coat can be fired at a third temperature that is lower than the second temperature. The decal has a predetermined pattern on a carrier and has at least one open region. The carrier burns off and the predetermined pattern of the decal can form a porcelain enamel image fixed to the cover coat. The porcelain enamel image can have more than one color and the at least one open region can allow the preselected background color of the cover coat to show through and be incorporated into the image to form an identical color match in the image and the cover coat.

In particular embodiments, the base can be formed from a layer of black ground coat porcelain enamel. The base can have a layer of white porcelain enamel covering the black ground coat porcelain enamel layer. In some embodiments, the black ground coat porcelain enamel layer and the white porcelain enamel layer can be fired in two separate firings. In other embodiments, the black ground coat porcelain enamel layer and the white porcelain enamel layer can be fired in a single firing. At least one cover coat can be fired over the base. In some embodiments, two cover coats can be fired over the base. In some embodiments, the base and the at least one cover coat can be fired in a single firing. The predetermined pattern of the decal can be embedded in the cover coat.

The present invention also provides a method of producing a metal grill component with a porcelain enamel background coating in a preselected color having thereon a multi-colored porcelain enamel logo with one of the logo colors being formed from the porcelain enamel background coating. A porcelain enamel precursor can be applied to the metal grill component. The porcelain enamel precursor can be formulated to produce a porcelain enamel background coating in a first preselected color on the metal grill component when it is fired. The grill component can be fired with the background porcelain enamel precursor thereon at a first elevated temperature to produce a porcelain enamel background coating on the metal grill component in the first preselected color. A decal can be applied to the porcelain enamel background coating. The decal can have at least one porcelain enamel precursor which produces a second preselected color upon firing and additionally having an area that, upon firing, shows the porcelain enamel background coating in the first preselected color to thereby produce a multi-colored porcelain enamel logo having the first and second preselected colors on the porcelain enamel background. The grill component can be fired with the porcelain enamel background coating and with the decal thereon at a second firing temperature lower than the first firing temperature to thereby produce a metal grill component with a porcelain enamel background coating in a preselected first color having thereon a multi-colored porcelain logo with a portion thereof formed from the porcelain enamel background coating in the first preselected color.

In particular embodiments, one or more porcelain enamel base coatings can be applied to the metal grill component prior to applying the porcelain enamel precursor to the metal grill component. The one or more porcelain enamel base coatings can be a black ground coating. In some embodiments, the one or more porcelain enamel base coatings can be a white coating. Additionally, the one or more porcelain enamel base coatings can include a black ground coating and a white coating on top of the black ground coating. At least one porcelain enamel background coating can be fired. In some embodiments, two porcelain enamel background coatings can be fired. The one or more porcelain enamel base coatings and the at least one porcelain enamel background coating can be fired in a single firing. A metal grill cover and a grill having such a cover can be produced by the methods discussed above.

### BRIEF DESCRIPTION OF DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a front view of an embodiment of a grill of the present invention.

FIG. 2 is a side view of the grill of FIG. 1.

FIG. 3 is a front view of an embodiment of a cover for a grill.

FIG. 4 is a side view of the cover of FIG. 3.

FIG. 5 is an example of a logo of the present invention.

FIG. 6 is a front view of an embodiment of another cover for a grill.

FIG. 7 is a side view of the cover of FIG. 6.

FIG. 8 is a schematic drawing showing a portion of a porcelain enamel article being formed in one embodiment of the present invention.

FIG. 9 is a schematic drawing showing a porcelain enamel image embedded in a porcelain enamel cover coat.

### DETAILED DESCRIPTION

The present invention can provide desired preselected colors or color shades of porcelain enamel. In addition, the present invention can provide a method of forming a porcelain enamel article including firing a porcelain enamel base or base coating over a metal substrate at a first temperature. At least one porcelain enamel cover coat or background coating can be fired over the base at a second temperature that is lower than the first temperature. The fired cover coat can form a preselected background color. A decal applied over the cover coat can be fired at a third temperature that is lower than the second temperature. The decal can have a predetermined pattern on a carrier and at least one open region. The carrier can burn off and the predetermined pattern of the decal can form a porcelain enamel image fixed to the cover coat. The porcelain enamel image can have more than one color, and the at least one open region allows the preselected background color of the cover coat to show through and be incorporated into the image to form an identical color match in the image and the cover coat.

In particular embodiments, the base can be a layer of black ground coat porcelain enamel, or a layer of white porcelain enamel. In some embodiments, the base can have a layer of white porcelain enamel covering the black ground coat porcelain enamel layer. The black ground coat layer can form the porcelain enamel base, or can be the first porcelain enamel layer in the porcelain enamel base covering the substrate. The white porcelain enamel layer can be used when the cover coat is a light or bright color, such as red, orange, light blue, etc. The black ground coat porcelain enamel layer and the white porcelain enamel layer can be fired in separate firings, or in a single firing. Additionally, the base (one or two layers) and one or more cover coats, can be fired in a single firing. The formulations or precursors for the base layers and the cover coat can each be applied as a wet slurry before firing. In cases where more than one layer is fired in a single firing, for example, for firing black ground coat and white porcelain enamel base layers in a single firing, the overlying white porcelain enamel layer can be applied as a drier slurry having less liquid for reducing or preventing undesirable interactions with the underlying black layer. Such undesirable interactions can include electrolyte interactions, which can cause the base layer not to bond with the metal substrate. The white porcelain enamel layer can in some embodiments, form a white mid coat.

The predetermined pattern of the decal can be embedded in and integral with the cover coat. In some cases, the porcelain enamel image can tactilely feel like part of the cover coat.

The porcelain enamel can be formed on the metal substrate for decorative purposes, and can be on various articles, including appliances or consumer products. The porcelain enamel article can include embodiments of a barbeque grill including porcelain enamel surfaces with specific desired preselected colors or color shades, and images or logos. For example, the lid of a grill can have colors and logos of an organization, such as a sports team, company, club, etc. The preselected background color can be incorporated into desired regions of the image of the logo. Examples of embodiments in the present invention are included in the descriptions and drawings. An example of a design of a barbeque grill in the present invention is shown, but it is understood that gas and charcoal grills of other designs are contemplated.

Matching colors or color shades in porcelain enamel can be performed in the present invention and the following description includes details of forming some particular colors. The formulations or precursors can include inorganic pigments that withstand high temperatures, for example, titanium dioxide, chromium oxide, cobalt aluminate, cadmium sulfo-selenide, and various other cobalt and selenium compounds, etc., and can additionally include ground glass (frit), magnesium carbonate, clay, sodium nitrite and bentonite. These ingredients can be ground to a particle size where only about 1%-6% of the particles will remain behind on a 200 mesh screen when the particles are passed through the screen, and typically about 1%-2%. Water can be added to form a slurry for application purposes. Pigments are typically added to the wet enamel slurry as the last step in the blending process. Percentages of the ingredients or formulations for particular colors can be altered, as well as the firing temperature and time, for matching specific color shades. Firing temperatures for various coats or layers and embodiments have been provided. The firing temperatures described, for example, for the base or ground coat, the cover coat, and the decal, can be each altered about ±20° C., but more typically within about ±10° C. Each successive firing can be at a lower temperature to prevent or reduce undesirable changes in the current or previously fired layer(s). The specific color shades provided can be identified as the shades of particular schools, organizations or teams, as indicated. Although decarburized steel is one preferred metal substrate, other suitable metals known in the art can be used. The decals include ingredients, precursors or formulations for porcelain enamel, for one or more colors, and can also include color matching.

Below are examples of specific color formulations for the cover coat that can be used. Each formulation can specify an enamel base (base materials for the formulation which often are unpigmented), the pigment and its amount added, the firing time and temperature. In cases where the firing time is indicated as 0 seconds, the article is in the furnace and is removed once the temperature rises to reach the desired temperature. Some of the formulations are for specific school, team or organizational colors, and have the specific desired shade of the color.

Purple—P-268—LSU/Clemson University
Clear Enamel Base
Mason Color K-7067 Violet 13%
Mason Color 6021 Red 0.5%
Over White Mid Coat
40 Seconds at 785 degrees C.

Light Blue—P-278—University of North Carolina
* White Enamel Base
Mason Color 6338 Cobalt Meta Silicate 5%
Over Black Ground Coat
40 Seconds at 785 degrees C.
* This is unique in that pigment is not typically added to white base enamel

Green—P-5535—Philadelphia Eagles (NFL)
Clear Enamel Base
Mason K-7069 Green 8%
40 seconds at 785 degrees C.

Yellow—P-116—University of Michigan
Clear Enamel Base
Mason Color K-7064 Yellow 4%
Mason Color 6485 Orange 1%
Over White Mid Coat
40 Seconds at 785 degrees C.

Blue—P-282—University of Michigan
Clear Enamel Base
Mason Color 6300 Mazerinne Blue 4%
Over Black Ground Coat
40 Seconds at 785 degrees C.

### Orange—P151—University of Tennessee

Clear Enamel base
Ferro Yellow 9621 5%
Ferro Red 9624 1%
Over White Mid Coat
0 Seconds at 795 degrees C.

Red—P-201—University of Alabama
Clear Enamel Base
Sumter Red P26310-H 3%
Over White Mid Coat
0 Seconds at 795 degrees C.

Red—P-202 Boston College/Florida State University
Clear Enamel Base
Sinopia Color #1 Red 3%
Sinopia Color #4 Red 0.25%
Over White Mid Coat
40 Seconds at 785 degrees C.

OR
Clear Enamel Base
Kremer #2 Red 3%
Over White Mid Coat
0 seconds at 795 degrees C.

Blue—P-289—New England Patriots (NFL)
Clear Enamel Base
Mason K-7065 4%
40 seconds at 785 degrees C.

Red—P-486—New England Patriots (NFL)
Clear Enamel Base
White Mid Coat
James M. Brown 4530 3%
0 seconds at 795 degrees C.

The particular ingredients designated with the prefixes Ferro, Mason, Sumter, Sinopia, Kremer and James M. Brown, are commercially available from the following respective companies, The Ferro Corporation, Washington, Pa., Mason Color Company, East Liverpool, Ohio, Sumter Paint Company, Sumter, S.C., Sinopia, San Francisco, Calif., Kremer Pigments, New York, N.Y. and James M. Brown, LTD, London, England.

In embodiments of the present invention, the formulations of porcelain enamel can form a substantially vitreous or glassy inorganic coating bonded to metal substrate surfaces of an article by melting and fusion at a temperature above 800° F. (425° C.). The glass-hard surface assures a long lasting finish, that is easily cleaned and maintained. Inorganic pigment compounds fused into the glass matrix can be extremely stable during aging and the colors can be highly resistant to deterioration or change. Porcelain enamels provide wear and abrasion resistance, while contributing to the strength of the metal substrate. Porcelain enamel is thermal shock resistant, and can be a suitable coating for articles subjected to heat. Porcelain enamel can provide a coating that readily withstands the expansion and contraction of the base metal substrate under changing temperature conditions.

Although, porcelain enamel has many characteristics and attributes that make it a good choice for outdoor cooking appliance products, it is not an easy or simple process to correctly apply this material to a grill lid and have matching colors on both the cover coat on the lid and within the logo. First, a formulation for the desired color shade must be created. The material can then be sprayed (“wet process”) or applied as an electrostatic powder (“dry”) coating process onto the grill lid. The coated lids (if a wet process is used) can be dried such as in an oven to create a bisque. The coated lid or dried bisque can be fired in a furnace, for example, in some cases at 750 to 800° C., or in other cases, up to 825° C. The exact temperature and firing time is dependent on the color or frit formulations. Therefore, special care is taken on the formulation of the various colors to develop a material that will fire at a consistent temperature and firing time.

Once the porcelain enamel has been applied to the grill lid, the decal or decoration of the logo or image design can be applied. These decals can be made specifically for this application and can include high temperature inks or pigments. Colors, after firing, should match the required colors of the logo design. When multiple colors are in the image, a layered decal can be used. Likewise, certain light or bright colors may require a backing color depending on the color of the porcelain enamel onto which it will be applied.

There are different methods of decal application that can be used. The typical water slide decal is essentially the same technique used on toy plastic models. Another method is a heat transfer decal that can require machinery to locate, place and affix the decal to the substrate, such as a grill lid. Once the decal is properly applied to the lid, if wet, it can be dried such as in an oven prior to being fired in the furnace. When properly fired, the design in the decal can become permanently emblazoned into the surface of the grill lid. Similar to the application of the porcelain enamel cover coat, each decal can be engineered to fire at a certain temperature for a certain firing time.

The design for each decal can be chosen that is the most appealing, and that will allow the appropriate amount of lid background cover coat color to show through after firing. In a decal, the number of colors in the decal can be limited by substituting the lid color, where possible. The color areas of the decal where the lid or cover color of the cover coat will show through can be removed to form open regions. This can allow the appropriate amount of lid color to show through, revealing the perfect color match, and the appearance that the decal is imbedded in the lid finish. This can reduce the total number of colors in the decal, to decrease the number of “layers” in the decal. The open regions of the decal allow the cover coat color to show through and be incorporated into the image formed on the cover coat after firing. The open regions can be physically open regions in the decal, or uncolored regions in the decal. In some embodiments, the carrier of the decal can extend across the open regions, and is burned off during firing. In some cases, there may be some color or text present on the carrier in the open regions of the decal for various purposes, for example to help make the particular decal easily visually identifiable, and which burn off during firing.

The following is one example of steps that can be performed for forming a porcelain enamel article, such as a grill component.

1. The substrate can be 18 gage, Type I decarburized porcelain enamel steel.

2. The substrate can be first cleaned and prepared so as to remove any rust and organic contaminants. Rust can be removed by orbital sanding with a fine grit, aluminum oxide emery paper. The surface is not required to be acid etched. Organic contaminants can be removed by thoroughly scrubbing with an industrial grade bio-degradable cleaner. The cleaned substrate can be then rinsed with clean water and dried with heat.

3. A black liquid porcelain enamel base or ground coat can be applied by conventional air spray techniques to the substrate at a rate to achieve 36 grams (wet) per square foot, and oven dried at 130° F. for 15 minutes to create a bisque.

4. The bisque can be then placed inside a batch furnace that is set for 820° C. The furnace door is opened and the articles are placed inside and the door is closed. Although this process takes but a few seconds, the drop in temperature can be approximately 100° C. When the furnace regains the temperature back to 820° C., a timer can be set for 40 seconds. The articles are removed from the furnace immediately after this period of time. The articles have now been fired for 40 seconds at 820° C. Total time in furnace can be approximately 12 minutes. Dry film thickness after firing can be 4-6 mils.

5. A cover coat of the desired pre-selected color shade can be applied on top of the base or ground coat in a similar manner as described above. A black cover coat, for example, can be fired for 40 seconds at 785° C. Times and temperatures for firing cover coats having other particular colors have been previously provided above. The cover coat can be applied at a rate of 26 grams (wet) per square foot. Total dry film thickness of both coats together after firing can be 8 to 12 mils. Bright colors such as red, orange, light blue, etc. can receive a white mid/cover coat to be applied over the ground coat and prior to the color cover coat. The white mid/cover coat can be applied and fired the same as a color cover coat.

6. A water slide decal can be placed in a pan of lukewarm water for about three minutes. The decal can be placed on the article on the cover coat while wet. The backing can be slid away leaving the top portion to remain on the article. The adhered decal can be flattened with an automotive-type windshield squeegee so as to remove any trapped air and water at the cover coat decal interface. Excessive moisture on the article can be blotted up with a towel.

7. The articles having a decal can be placed into a drying oven, which can be near the end of the work day and given an initial drying of 130° F. for roughly 60 minutes. The articles can be left in the warm oven overnight to assure a thorough drying process.

8. The furnace can be set to 720-740° C. depending on the decal and allowed to come up to temperature. Thin decals will fire at a lower temperature than thicker decals. The decal can be fired for 30 seconds at the desired temperature using a procedure similar to step 4 above. Total time in furnace can be about 9-12 minutes. Upon cooling, the article is ready for use. In some embodiments, thicker decals can be fired by slightly increasing both the duration of time and the temperature, for example, increases of about 5° C. in temperature and about 15-30 additional seconds in duration.

In other embodiments, temperatures for firing a porcelain enamel base over a decarburized steel substrate can range from about 815-825° C., with about 819-821° C. often being preferred. Temperatures for firing a porcelain enamel cover coat over such a porcelain enamel base can range from about 780-800° C., with about 785-795° C. often being preferred. Temperatures for firing the decal over such a porcelain enamel cover coat can range from about 720-780° C., with about 730-760° C. often being preferred. It is understood that firing temperatures can be varied, for example, temperatures can be lower for firing over an aluminum substrate, and temperatures can be higher for firing over a cast iron substrate, where different porcelain enamel formulations can be used for firing at the different higher and lower temperatures. In some embodiments, the cover coat can often be fired about 25-35° C. lower than the base, and the decal can often be fired about 45-75° C. lower than the cover coat.

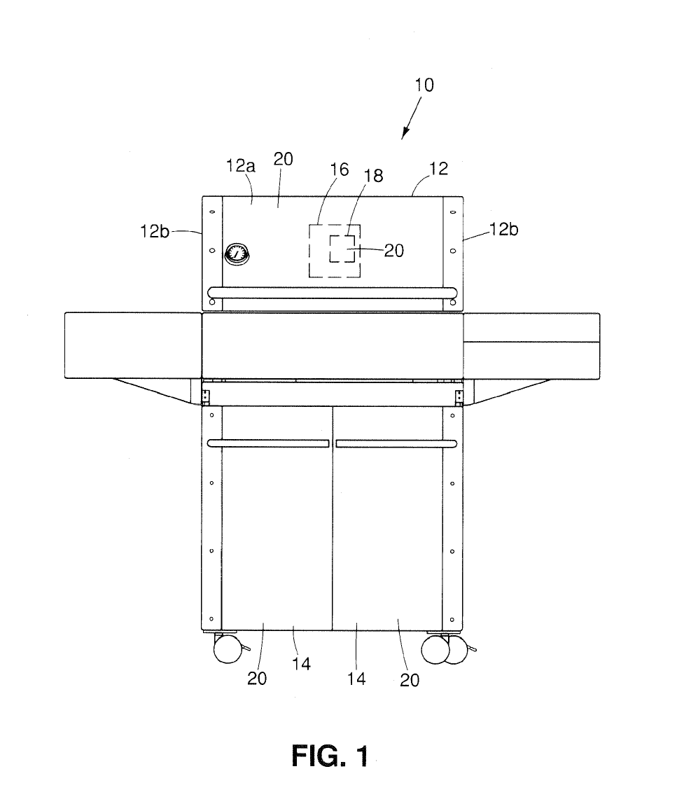

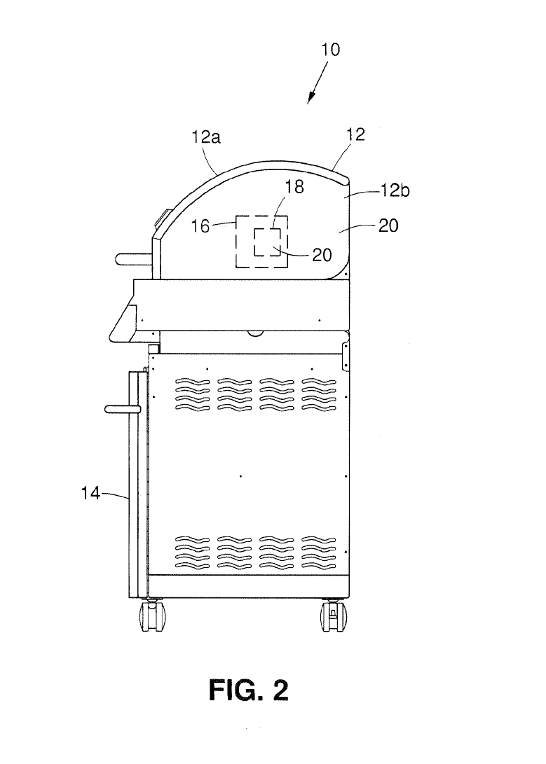

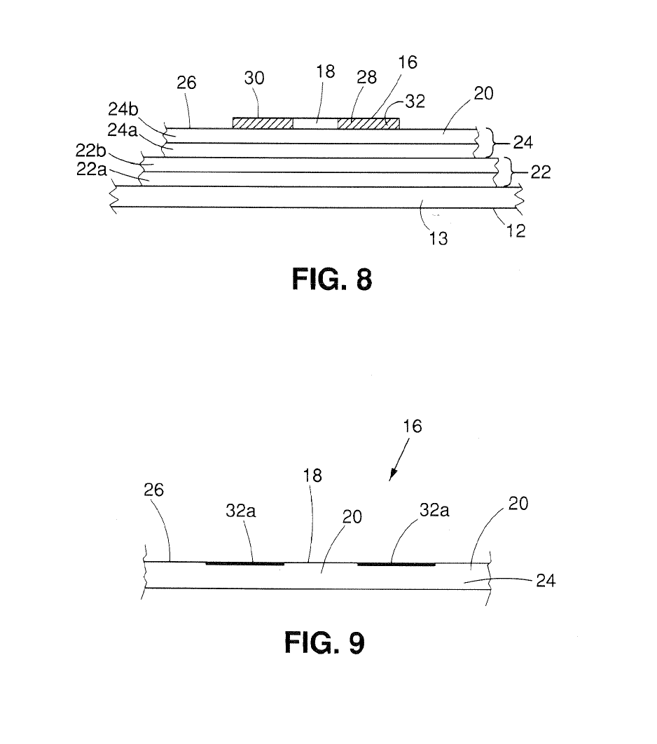

FIGS. 1 and 2 depict an embodiment of a grill 10 in the present invention, for example, a gas grill, having porcelain enamel metal grill components or articles, for example, a lid or cover 12, and doors 14 to a storage space. The cover 12 and the doors 14 can have a metal substrate 13 (FIG. 8) with a porcelain enamel base or base coating 22, and a porcelain enamel cover coat or background coating 24, which can have a specific desired preselected color 20, for example, the exact color shade of a color of a team, school or organization. The cover 12 can have a porcelain enamel logo or image 16 with a predetermined pattern or design, which can represent or relate to the team, school or organization corresponding to the color 20. The image 16 can be produced using a decal 28 (FIG. 8) and can include the color 20 within the design of the image 16, among one or more other colors in the image 16 that are provided by the decal 28. In order to obtain an exact color match between the color 20 within the image 16 and the color 20 of the cover coat or background coating 24, the decal 28 used can have one or more open regions 18 which can allow the color 20 of the cover coat or background coating 24 to show through and be incorporated into the image 16, thereby forming the identical color match. If the color 20 for image 16 were to be instead provided in the decal 28 itself, which is fired later and at a lower temperature than the cover coat or background coating 24, there could be color mismatches between the color 20 of the cover coat 24 and the color 20 within the image 16.

The cover 12 can have the logo or image 16 on the front 12a and two sides 12b. In addition, other configurations or locations for positioning the image 16 can be used, and the doors 14 can also include the image 16. In addition, personalized porcelain enamel images including those relating to the owner of the grill can also be included. The cover 12 and doors 14 having matching colors 20 for particular organizations can be included in or form a kit which can be installed on a grill 10. The cover 12 and doors 14 can be interchangeable so that a sports fan or user can switch the cover 12 and doors 14, depending on which sports team or organizational event he/she will be attending. Furthermore, other portions or components of the grill 10 can include porcelain enamel colors 20 and images 16

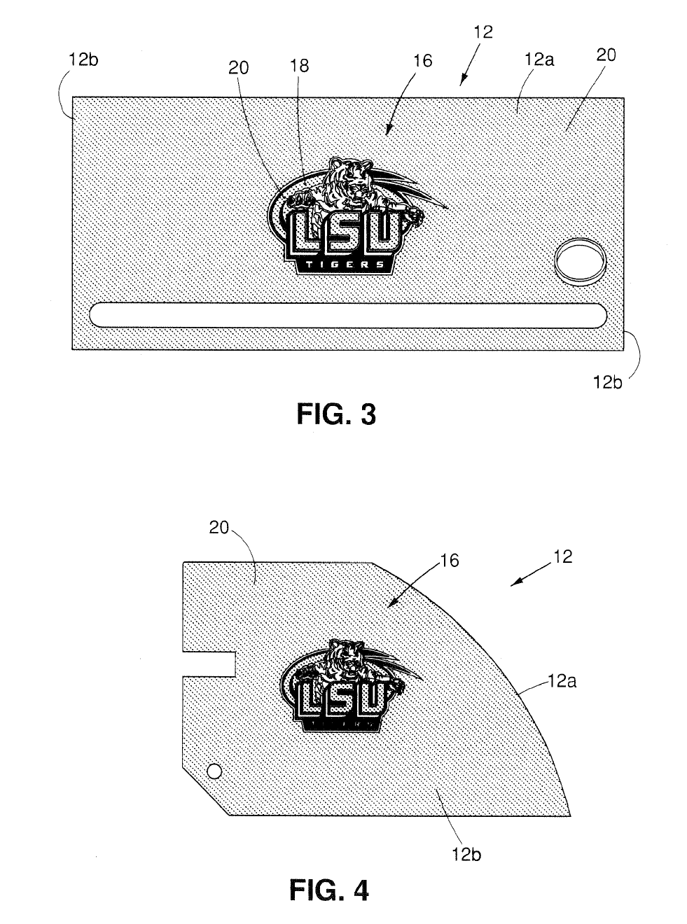

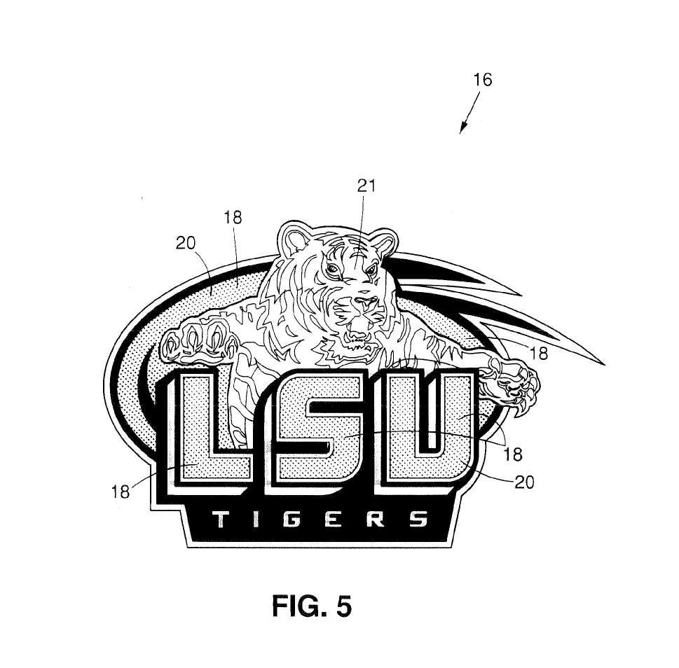

FIGS. 3 and 4 depict an example of an embodiment of a lid or cover 12 for grill 10 having a porcelain enamel cover coat or background coating 24 which has a color 20 that is a team color of LSU (Louisiana State University), and has LSU logos or images 16 (FIG. 5), on the front 12a and sides 12b. The color 20 of the cover coat or background coating 24 can be LSU purple P-268. Referring to FIG. 5, the image 16 can have multiple preselected colors and can include a number of open regions 18, such as regions within the letters LSU, and certain regions surrounding the tiger, in which the color 20 of the cover coat 24 is incorporated into the multi-colored porcelain enamel image 16. The decal 28 used for image 16 has formulations for multiple preselected colors, as well as open regions 18 to allow the color 20 of the cover coat 24, LSU purple P-268, to show through and be incorporated into the LSU logo or image 16, thereby forming an exact match of the color 20 of the cover coat 24 and within the image 16. Other colors 21 in the LSU logo or image 16 can include black, white, and gold or yellow, which can be provided by the decal 28.

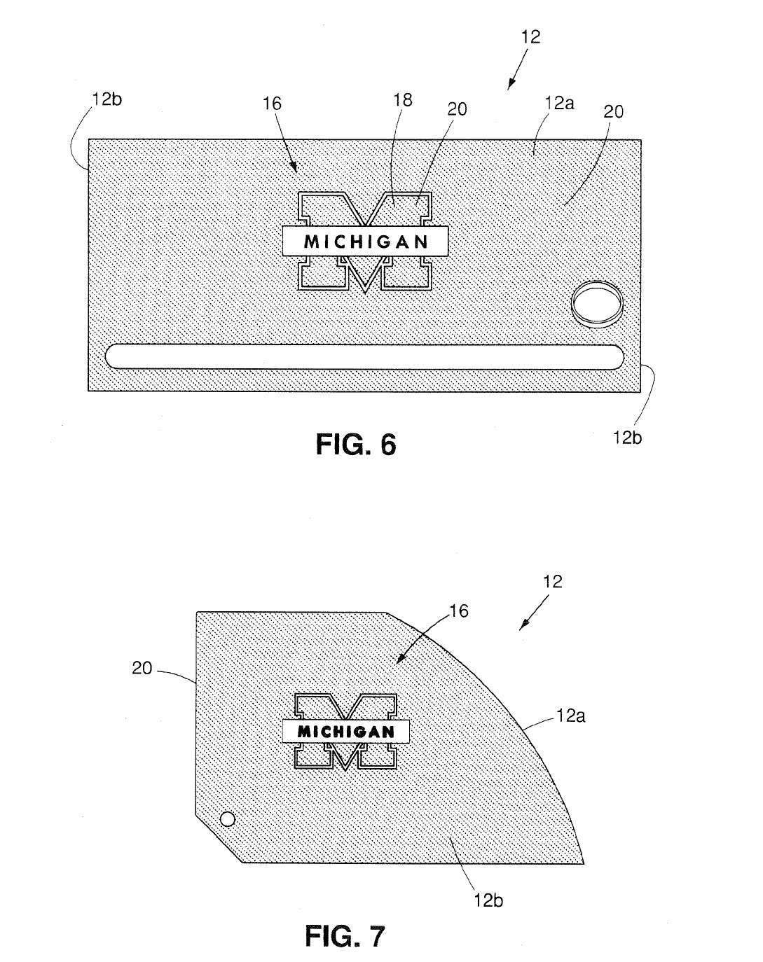

FIGS. 6 and 7 depict another example of an embodiment of a lid or cover 12 for grill 10 having a porcelain enamel cover coat or background coating 24, which has a color 20 that is a team color of Michigan (University of Michigan), and has multi-color Michigan logos or images 16 on the front 12a and sides 12b. The color 20 of the cover coat or background coating 24 can be Michigan blue P-282. The image 16 can include open regions 18 in which the color 20 of the cover coat 24 is incorporated into the image 16. The decal 28 used for image 16 has a formulation for a preselected color, as well as open regions 18 to allow the color 20 of the cover coat 24, Michigan blue P-282, to show through and be incorporated into the Michigan logo or image 16, thereby forming an exact match of the color 20 of the cover coat 24 and within the image 16. The other preselected color in the Michigan logo or image 16 can be Michigan yellow P-116, of which the formulation can be provided by the decal 28.

It is understood that different school, team or organizational colors can be used as the cover coat 24 and in the image 16, and schools, teams or organizations often have more than one color associated with them.

FIG. 8 depicts an embodiment of a portion of a porcelain enamel article being formed, such as a metal grill component or a cover 12 for a grill. The cover 12 can have a metal substrate 13. A porcelain enamel base or base coating 22 can be fired over the substrate 13, such as previously described. In some embodiments, the base 22 can have two layers 22a and 22b. In some embodiments, the layer 22a can be a layer of black ground coat porcelain enamel, and the layer 22b can be a layer of white porcelain enamel. As previously described, a porcelain enamel cover coat or background coating 24 of a preselected color 20 can be fired over the base 22. In some embodiments, the cover coat 24 can have two layers 24a and 24b. The two layers 24a and 24b can be fired separately in succession. Firing the cover coat 24 in two layers 24a and 24b can for certain colors, for example some yellows, produce a more consistent preselected color match with the desired shade. If desired, the cover coat 24 can have more than two layers. The image 16 can be formed by applying a decal 28 on the cover coat 24. The decal 28 can have a predetermined pattern on a carrier 30 and at least one porcelain enamel formulation or precursor 32 to form at least another or a second preselected color 32a, within the image 16, when the decal 28 is fired. Firing the decal 28 as previously described, burns off the carrier 30 and produces or fuses a multi-colored porcelain enamel logo or image 16 that is fixed to the cover coat 24. The open regions 18 of the decal 28 allow the color 20 of the cover coat 24 to show through and be incorporated into the image 16 so that the image 16 includes at least the first preselected color 20 and the second preselected color 32a. As previously discussed, the decal 28 can include formulations for multiple colors. The image 16 can become embedded in the surface 26 of the cover coat 24, and where the color 20 of the cover coat 24 can be incorporated into the image 16. The image 16 can have the tactile feeling of being part of the cover coat 24. As can be seen, in some embodiments, five porcelain enamel steps or five firings can be performed in the process. In other embodiments, as previously discussed, selected multiple layers can be fired together in a single firing, which can reduce the number of firings performed.

While this invention has been particularly shown and described with references to example embodiments thereof, it will be understood by those skilled in the art that various changes in form and details may be made therein without departing from the scope of the invention encompassed by the appended claims.

1. A method of forming a porcelain enamel article comprising:
firing a porcelain enamel base over a metal substrate at a first temperature;
firing a porcelain enamel cover coat over the base at a second temperature that is lower than the first temperature, the fired cover coat forming a preselected background color; and
firing a decal applied over the cover coat at a third temperature that is lower than the second temperature, the decal having a predetermined pattern on a carrier and having at least one open region, the carrier burning off and the predetermined pattern of the decal forming a porcelain enamel image fixed to the cover coat, whereby the porcelain enamel image has more than one color, and the at least one open region allows the preselected background color of the cover coat to show through and be incorporated into the image to form an identical color match in the image and the cover coat.

2. The method of claim 1 further comprising forming the base from a layer of black ground coat porcelain enamel.

3. The method of claim 2 further comprising forming the base with a layer of white porcelain enamel covering the black ground coat porcelain enamel layer.

4. The method of claim 3 further comprising firing the black ground coat porcelain enamel layer and the white porcelain enamel layer in two separate firings.

5. The method of claim 3 further comprising firing the black ground coat porcelain enamel layer and the white porcelain enamel layer in a single firing.

6. The method of claim 1 further comprising firing at least one cover coat over the base.

7. The method of claim 6 further comprising firing two cover coats over the base.

8. The method of claim 6 further comprising firing the base and the at least one cover coat in a single firing.

9. The method of claim 1 further comprising embedding the predetermined pattern of the decal in the cover coat.

10. A method of producing a metal grill component with a porcelain enamel background coating in a preselected color having thereon a multi-colored porcelain enamel logo with one of the logo colors formed from the porcelain enamel background coating, comprising:
applying a porcelain enamel precursor to the metal grill component, said porcelain enamel precursor being formulated to produce a porcelain enamel background coating in a first preselected color on the metal grill component when it is fired;
firing the grill component with the background porcelain enamel precursor thereon at a first elevated temperature to produce a porcelain enamel background coating on the metal grill component in the first preselected color;
applying a decal to the porcelain enamel background coating, said decal having at least one porcelain enamel precursor which produces a second preselected color upon firing and additionally having an area that, upon firing, shows the porcelain enamel background coating in said first preselected color to thereby produce a multi-colored porcelain enamel logo having said first and second preselected colors on said porcelain enamel background; and
firing the grill component with the porcelain enamel background coating with said decal thereon at a second firing temperature lower than said first firing temperature to thereby produce a metal grill component with a porcelain enamel background coating in a preselected first color having thereon a multi-colored porcelain logo with a portion thereof formed from the porcelain enamel background coating in the first preselected color.

11. A method of claim 10 comprising applying one or more porcelain enamel base coatings to said metal grill component prior to applying said porcelain enamel precursor to the metal grill component.

12. A method of claim 11 wherein said one or more porcelain enamel base coatings is a black coating.

13. A method of claim 11 wherein said one or more porcelain enamel base coatings is a white coating.

14. A method of claim 11 wherein said one or more porcelain enamel base coatings comprise a black ground coating and a white coating on top of the black ground coating.

15. A method of claim 11 wherein at least one porcelain enamel background coating is fired.

16. A method of claim 15 wherein two porcelain enamel background coatings are fired.

17. A method of claim 15 wherein the one or more porcelain enamel base coatings and the at least one porcelain enamel background coating are fired in a single firing.

18. A metal grill cover produced by any the method of claim 10.

19. A grill having a cover produced by claim 18.
